(19) United States
(12) Patent Application Publication
(10) Pub. No.: US 2005/0044019 A1
(43) Pub. Date: Feb. 24, 2005

(54) System and method for providing a backstop facility in support of the issuance of extendable asset-backed commercial paper

(76) Inventors: Robert Novick, Mamaroneck, NY (US); John Costa, South Salem, NY (US); Harold Gartner, Atlantic Beach, NY (US)

Correspondence Address: KENYON & KENYON, One Broadway, New York, NY, 10004, US

(21) Appl. No.: 10/634,224

(22) Filed: Aug. 4, 2003

(51) Int. Cl. G06F 17/60

(52) U.S. Cl. 705/35; 705/1

(57) ABSTRACT

A system and method for providing backstop liquidity for an extendable commercial paper issue used to finance asset-backed securitization transactions through an up-front commitment from a highly rated entity to purchase fixed-income securities. A conduit that issues extendable commercial paper backed by a plurality of asset securitization transactions obtains a triple-A rated guaranty for each of the plurality of asset-backed securitization transactions and secures an up-front commitment from a highly rated backstop provider to purchase fixed-income securities to be issued in the future by such conduit (or an affiliated conduit) to retire such conduit's outstanding extendable commercial paper in the event that the conduit is unable to retire such commercial paper before the end of its extension period. The extendable commercial paper includes secured liquidity notes (SLNs) and the fixed-income securities include asset-backed medium-term notes (MTNs).

### FIELD OF THE INVENTION

The present invention relates to the financing of asset-backed securitization transactions through an asset-backed commercial paper conduit (the “conduit” or “conduit issuer”), and in particular relates to a system and method for providing a backstop facility to a conduit issuing an extendable asset-backed commercial paper (“extendable CP”) issue. Such backstop facility is provided to the conduit by a highly rated entity through its up-front commitment to purchase a future series of conduit-issued asset-backed securities, the proceeds of which would be used to retire all outstanding payment obligations relating to the above-mentioned extendable CP issue. Such a backstop facility is an alternative to traditional bank liquidity facilities and other financial derivatives used to retire outstanding extendable CP.

### BACKGROUND INFORMATION

The US asset-backed commercial paper (“ABCP”) market is growing rapidly and is believed to have reached 800 billion dollars in 2002. ABCP generally constitutes short-term notes or obligations that are secured by a variety of receivables, such as, for example, credit card receivables, automobile loans, home equity loans, and commercial trade receivables. As a subset of the market for ABCP, the market for extendable CP has been gaining momentum in the capital markets. The rapid growth of the ABCP and extendable CP market is beginning to outstrip the capacity of banks to provide traditional liquidity facilities for facilitating and supporting ABCP issuance.

Extendable CP relieves pressure on the commercial paper conduit issuers and their related liquidity facility providers in that such facility providers do not have to provide funds on the exact date that the CP matures. This relief is especially timely in view of recent changes to U.S. GAAP (Generally Accepted Accounting Principles) that require liquidity providers to consolidate conduit assets.

While traditional CP maturities typically range from 1 to 270 days, extendable CP has a maximum maturity of 390 days from issuance. Extendable CP operates like traditional CP until the occurrence of either a severe, conduit-specific problem or a market disruption event (each an “MDE”), at which time the maturity of the outstanding extendable CP is extended (“extended CP”) for up to an upper limit of 390 days from issuance. During its normal, non-extended lifetime, the yield on extendable CP is typically 2-5 basis points higher than traditional CP to compensate investors for the risk of extension of the maturity date. If and when an extension event occurs, extendable CP investors generally receive a “step-up” in yield during such extension period to approximately LIBOR (London InterBank Offer Rate) plus 25 basis points per annum.

The kinds of MDEs that could necessitate an extension of an extendable CP issue are similar to the events of Sep. 11, 2001. Such a catastrophic event can cause CP investors to require repayment of maturing CP, while conduit issuers may be unable to retire maturing CP with proceeds from newly issued CP (such refinancing commonly referred to as a “rollover”). The inability to rollover maturing CP traditionally results in a same-day funding obligation for the liquidity facility providers, which must, despite any associated difficulties, always be assured of their ability to discharge their obligations to retire maturing CP on time.

There are three types of extendable CP currently in use: (i) Trust Liquidity Notes (“TLNs”), (ii) Secured Liquidity Notes (“SLNs”), and (iii) Callable Notes (“CNs”). TLNs are issued by a conduit having homogenous assets (typically originated by one financial institution) as collateral, such as originator-specific credit card receivables. TLN investors primarily look to the strength of the cash flow arising from the underlying receivable collateral for repayment by the end of the extension period and secondarily to a small (e.g., 15%) backstop facility with a rated counterparty in case there is a shortfall in the actual cash collected. This partial backstop facility is usually in the form of a traditional bank liquidity facility. TLNs tend to be difficult to issue when there are multiple asset classes originated by more than one financial institution (an “originator/seller”).

SLNs, like traditional CP, rely on an agreement with a backstop facility provider to retire CP when required. Specifically, during an extension period, collections from underlying receivable collateral may be used to amortize the SLNs, but if they are not completely retired by the end of the extension period, then the backstop facility provider retires the outstanding SLNs pursuant to the backstop facility agreement between such provider and the conduit issuer. The credit rating of this type of extendable CP issue, therefore, focuses on the strength of the backstop facility agreement and the short-term debt rating of the backstop facility provider. Such ratings are typically provided by the nationally accredited rating agencies, such as Moody's Investors Service (“Moody's”) and Standard & Poor's.

Callable Notes have short-term maturities as long as 390 days, with a non-call period of shorter duration (e.g., 30 days). The ability to call a CN is dependent on the ability of the conduit to issue additional CNs. (CNs are structured in this fashion in order to facilitate their purchase by certain money market funds that cannot buy extendable CP.)

The market for SLNs is growing in particular as dealers and market-makers are expanding the investor base for these instruments. While some SLN investors are traditional CP investors hoping to obtain the extension premium, many SLN investors are non-traditional CP investors. The market for SLNs is growing beyond the capacity of banks to provide traditional bank-provided liquidity to serve as backstop facilities for SLN issues.

In view of the recent regulatory trend towards requiring traditional liquidity facility providers to consolidate conduit assets onto their balance sheets, the difficulties of maintaining funds available for same-day funding obligations, and the overall inability of traditional liquidity providers to meet the rapidly growing demand for liquidity in the ABCP market, it would be useful to provide an alternative backstop facility for extendable CP that does not rely on bank-provided, same-day liquidity.

### SUMMARY OF THE INVENTION

According to one aspect, the present invention provides a method of facilitating issuance, by a conduit, of extendable CP backed by a plurality of asset securitization transactions in which a triple-A rated financial guaranty is obtained for each of the plurality of asset-backed securitization transactions. An up-front commitment is secured by such conduit from at least one highly rated, third-party, backstop-facility provider (i.e. rated at least A-1/P-1 by Standard & Poor's and Moody's, respectively) (herein referred to as a “committed purchaser”) to purchase one or more new series of triple-A rated, fixed-income, asset-backed securities issued by the same conduit (or an affiliated conduit). The proceeds of such new securities issuance would be used to retire the conduit's outstanding extended CP.

According to one embodiment, the fixed-income securities that the committed purchaser commits to acquire include asset-backed medium-term notes (the “MTNs”), i.e., debt instruments that typically have stated maturities of between 1 to 5 years. The extendable CP issued may include SLNs and may also include CNs. The triple-A rated financial guaranties are provided by triple-A rated monoline bond insurers, guarantying the timely payment of interest due and the ultimate repayment of principal owed under each individual securitization transaction financed by the conduit. The backstop-facility provider (i.e., the committed purchaser) does not have to be a bank and may include any qualified entity with an appropriate short-term debt rating. A lead underwriter, which is a licensed NASD member firm and an MTN broker/dealer, manages the sale of MTNs to the committed purchaser or purchasers. The lead underwriter is also typically one of the committed purchasers. The conduit will be managed by a conduit administrator (the “conduit administrator”). The conduit administrator notifies the lead underwriter of the administrator's intent to retire outstanding extended CP through a sale of fixed-income securities to the lead underwriter and the other committed purchasers prior to the end of the extension period of the extended CP.

The interest rate of the MTNs may be decided upon when the committed purchasers are requested to purchase the MTNs. Thus, the interest rate of such MTNs reflects the prevailing market conditions for comparable securities at that time. The lead underwriter may be notified a preset period from the inception of the extension period of a request to execute its purchase of the MTNs to retire the outstanding extendable CP. However, the lead underwriter may not be requested to purchase the MTNs if the MDE is cured before the end of the extension period.

According to yet another aspect, the present invention provides a backstop facility for ensuring the retirement of extended CP by a final maturity date by an entity (i.e., the committed purchaser) that agrees to purchase fixed-income securities (e.g., the MTNs) issued by the conduit issuer of the extendable CP. Such fixed income securities issuance would be used to retire the outstanding extendable CP by its legal final maturity date. The committed purchaser may include a lead underwriter. According to one embodiment, the committed purchaser agrees to purchase MTNs after the occurrence of a MDE if the MDE has not been cured before the legal final maturity date of the conduit issuer's outstanding extended CP. To allow for adequate preparation, the committed purchaser may be notified by the conduit's administrator a preset period prior to the extendable CP's legal final maturity date to purchase the MTNs to retire outstanding extendable CP.

In yet another aspect, the present invention provides a financial structure for facilitating issuance of extendable CP. The financial structure includes a conduit for purchasing asset-backed securitization transactions and for issuing extendable CP to finance the purchase of such asset-backed securitization transactions, the extendable CP having an extendable maturity feature. A backstop-facility provider commits up front to purchase conduit-issued fixed-income securities in the future, the proceeds of which would be used to retire outstanding extended CP.

The financial structure may also include special purpose vehicles that securitize receivable assets into at least one of variable funding certificates and variable funding notes and finance such receivable assets by selling at least one of the variable funding certificates and variable funding notes to the conduit. Additionally, the financial structure may include a financial insurer that guarantees non-default for each of the asset-backed securitization transactions purchased by the conduit. The financial insurer preferably has a rating of at AAA/Aaa by Standard & Poor's and Moody's, respectively. In another embodiment, the financial structure may further include a conduit administrator that performs monitoring and administration functions on behalf of the conduit.

### BRIEF DESCRIPTION OF THE DRAWINGS

FIG. 1 is a block diagram of a financial structure for facilitating issuance of extendable CP according to an embodiment of the present invention.

FIG. 2a is an example flow chart of events related to an issuance of SLNs by the conduit according to the present invention.

FIG. 2b is a continuation of the flow chart of FIG. 2a.

### DETAILED DESCRIPTION

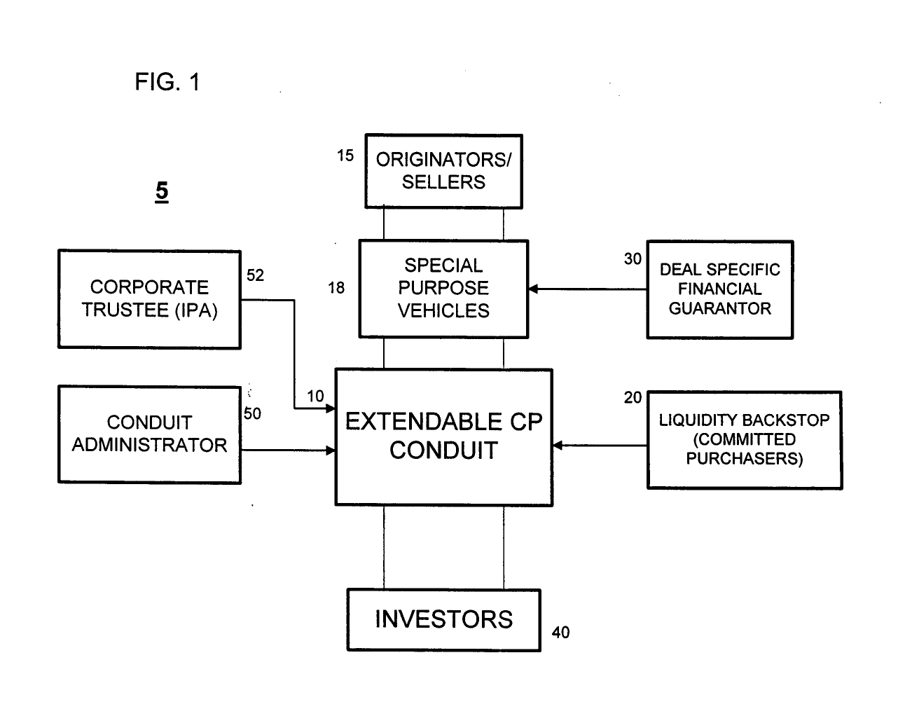

FIG. 1 illustrates a financial structure 5 for facilitating issuance of extendable CP according to an embodiment of the present invention. An extendable CP conduit 10, established as an independent entity, such as, for example, a Delaware limited liability company, is formed to issue extendable CP to investors 40 via reputable broker/dealers of extendable CP. Approximately 2 billion dollars par amount of extendable CP, but not necessarily such amount, primarily comprising SLNs and also possibly including CNs, is initially issued to reach a threshold for market acceptance and presence resulting in stable, efficient pricing of the SLNs (hereinafter the extendable CP will be referred to as SLNs, but it should be understood that the issued extendable CP may include a certain quantity of callable notes, for example).

The proceeds from the sale of the SLNs are used to purchase (and ultimately finance) structured asset-backed securitization transactions such as variable funding certificates (VFCs) or variable funding notes (VFNs) issued from special purpose vehicles (SPVs) or variable interest entities (VIEs) 18. The VFCs are in turn backed by large portfolios of receivables originated by various types of entities, including financial institutions and corporations (individually an “originator/seller”) 15. In this manner, the proceeds from the ABCP issued by the conduit 10 are passed through to the SPV 18 to finance the underlying receivable assets. Each asset-backed securitization transaction (VFC or VFN) presented to the conduit has the benefit of an individual triple-A financial guaranty provided from a financial guarantor 30. According to a particular implementation, the financial guarantor may comprise a single “monoline” that guarantees each and every VFC or VFN purchased by the conduit 10.

A conduit administrator 50, which in certain cases may be also be the owner of the conduit 10, oversees the administration of the conduit and may be responsible for originating, structuring and monitoring the various asset-backed securitization transactions to be financed. Generally, the conduit administrator 50 hires a financial institution that provides trust services and acts as the issuing and paying agent (“IPA”) 52.

The cost structure between the conduit 10, the Special Purpose Vehicle 18, and the originator/sellers 15 is arranged so that the originator/sellers agree to pay the conduit's cost of funds (plus a negotiated interest margin), whether that be the cost associated with SLNs during a normal non-extended period, the cost of SLNs during an extension period, or the cost of alternative securities used to retire outstanding SLNs described in greater detail below. Therefore, the conduit is insulated from spread risks in all scenarios.

Rather than relying on a bank sponsor to provide liquidity, the structure presented herein uses a commitment from one or more highly rated, fixed-income securities buyers (each a “committed purchaser”) 20. According to one embodiment, the committed purchaser 20 commits in advance to purchase asset-backed Medium Term Notes (MTNs) which are issued upon the occurrence of certain circumstances by the conduit 10 to retire maturing extendable CP. For its services, committed purchaser 20 receives a standby commitment fee.

Upon the occurrence of an extension event, each of the VFCs held by the conduit 10 could be triggered to begin amortization either immediately or upon expiration of the deal-specific funding commitment period. Proceeds from the amortization are then used to pay down outstanding SLNs. If one-hundred percent of the SLNs are not paid down within the upper limit (i.e., the legal final maturity) of 390 days, then a like-sized quantity of MTNs are issued solely to retire the SLNs. In other words, if certain transactions within the conduit have begun amortization with proceeds used to pay down the SLNs during the extension period, then the issuance size of the MTNs need only be sufficient to retire outstanding SLN amounts. Committed purchasers 20 receive amortization proceeds from the liquidation of conduit assets.

The committed purchasers 20 are given an opportunity to receive an “at-the-market” yield at the time they are required to purchase the upcoming MTNs. The MTNs will have an interest rate comparable to other triple-A rated securities at the time of the MTN issuance. As the conduit 10 charges a blended cost of funds based on the issuance of SLNs across various short-term maturities ranging from one to 90 days, the conduit may also charge a blended cost of funds under an MTN issuance, which may include tranching across the maturity profile of the underlying collateral.

During an extension period of an extendable CP issue, several things can occur: (i) the event which caused the extension event can cure itself, allowing for the resumption of issuance of new SLNs to replace (i.e., retire) maturing SLNs; (ii) if the event is cured, no MTN issuance (or draw upon a backstop facility) is necessary and additional SLNs would be issued to retire maturing SLNs (once an extension occurs, the SLN coupon steps-up to LIBOR plus 25 basis points per annum until the extended SLNs are retired); (iii) if the disruption is not cured and the 390 day extension period is ongoing, a committed MTN buyer is made aware of the likelihood that it will be required to purchase MTNs under its agreement. As noted above, the maturity amortization schedule of the MTNs is tied to the expected final maturity and the cash-flow collections of the underlying collateral (e.g. the credit card receivables, automobile loan, home equity loan, trade receivables, etc.) securing the VFCs.

To facilitate efficient marketing and issuance of the MTNs by the termination of an SLN extension period, the committed purchasers may include (or constitute) a lead underwriter. Like the other committed purchasers, the lead underwriter will enter into an MTN purchase agreement with the conduit whereby the lead underwriter commits itself to purchase a possible future issuance (or series of issuances) of fixed-income, asset-backed securities (e.g., asset backed medium-term notes) (in any case, the “MTN Takeout”). Unlike the other committed purchasers, the lead underwriter is typically responsible for structuring the MTN Takeout based on the underlying assets of the conduit, managing the respective rating agency process, further syndicating the firm underwriting commitment, and pricing the MTN Takeout. For example, the lead underwriter may determine, based upon the outcome of the rating agency process and market conditions, whether MTNs are backed by all of the underlying conduit assets or whether some MTN tranches would be backed by particular “ring-fenced” assets. After an MTN takeout is executed, the proceeds are then used to retire all outstanding SLNs.

Under the agreement between the committed purchasers and the conduit, the committed purchasers' commitment may be limited to a commitment period of, for example, one year. The commitment period may roll forward each month unless the committed purchasers provide a written termination notice to the conduit at a prescribed time. In the event that the committed purchasers deliver such a commitment termination notice to the conduit, and the conduit administrator is unable to replace the committed purchasers with alternative sources of liquidity support satisfactory to the rating agencies, the committed purchasers remain obligated to execute the MTN Takeout by the end of the commitment period and the conduit may be prohibited from issuing incremental tranches of SLNs. The committed purchasers' financial commitment will be matched to the expected aggregate outstanding amount of SLNs. This amount may be increased upon a request from the conduit administrator. However, the commitment amount at any time should not be less than the aggregate outstanding amount of SLNs.

The conduit administrator delivers notices of an intent to execute an MTN Takeout to respective originator/sellers and the lead underwriter indicating that the conduit intends to execute the MTN Takeout to retire outstanding extended CP. To enable all parties involved to adequately prepare for the MTN Takeout, the due date for such notification may be set to the earlier of, for example: (a) 30 calendar days after the inception and continuation of an SLN Extension Period, and, (b) 90 calendar days after the conduit administrator receives a commitment termination notice from a one or more committed purchasers unless the conduit administrator has found alternative sources of backstop support beforehand. However, if after sending the notice of intent the conduit regains its ability to issue SLNs, the conduit administrator may withdraw such notice. Immediately following its delivery of the notice of intent to execute an MTN Takeout, the conduit administrator may request MTN Takeout proposals from both the lead underwriter and competing asset-backed securities underwriters. Under the terms of the agreement between the conduit and the lead underwriter, if a competing underwriter offers a reasonable proposal that features more economical pricing (i.e., based on the coupon and price of the MTN) than the lead underwriter's original proposal, the lead underwriter may have the right to match the terms of such best offer within a certain number of business days. If the lead underwriter fails to match such best offer, the conduit administrator, subject to rating agency approval, may have the right to terminate the lead underwriter and transfer all of its rights and responsibilities to the underwriter that submitted the best offer. The conduit administrator may make such determination within a certain period after the original submission of the notice of intent to execute the MTN Takeout.

As described further below, the MTNs issued by the conduit will be fully supported by all rights arising from the financial guaranties supporting the individual asset-backed securitizations comprising the conduit's portfolio and will also be secured by a first priority perfected security interest in the conduit's assets.

Each of the conduit's asset purchases are structured to ensure that the transaction's credit quality (on a stand-alone basis) is commensurate with the conduit program's targeted ratings. Standard & Poor's, Moody's, and a guarantor review and approve each asset-backed securitization transaction (e.g., a VFC) before the conduit acquires it. The guarantor will ultimately issue a guaranty to ensure timely payment of the VFC's interest obligations and ultimate payment of the VFC's principal. This essentially means that the MTNs issued will be rated triple-A since they are supported entirely by triple-A-rated collateral. With guaranteed credit support, a default on any particular conduit transaction means SLN investors and MTN investors continue to receive timely payments of interest and ultimate payment of principal, as scheduled. Notwithstanding monthly cash collections arising from each VFC, principal and interest owed under each VFC financed by the conduit are therefore covered by the guaranty. In order to achieve a rating on the SLN's issued by the conduit, rating agencies also review the strength of the standby commitment agreement (i.e., the backstop facility agreement) between the committed purchaser(s) and the conduit.

The allocation of risk among the parties to the transactions described herein is as follows:
(i) liquidity risk: SLN investors bear the risk associated with an extension event and are compensated by receiving a higher yield than traditional ABCP investors. Similarly, SLN investors, like traditional CP investors, bear the risk that the backstop-facility provider designated to ultimately retire maturing SLN or CP is unable to do so. As noted above, in the case of the traditional CP investor, this is typically the risk of the conduit sponsor/administrator (typically a bank) having to raise same-day funds to repay maturing CP. With respect to SLNs, there is a substantial amount of time (via the extension period) available to obtain backstop funding. The liquidity risks then depend on the abilities of a) the designated committed purchaser(s) to find the necessary amount directly; b) the underlying originator/sellers to refinance their collateral away from the conduit; or c) as a last resort, for the amortization of the underlying financed receivables to payoff the SLNs by the end of the extension period. According to the structure of the present invention, the net liquidity risk to SLN investors is minimal because of the nature of the firm commitment on the part of the committed purchasers to provide a takeout in the case of any shortfall at the end of the extension period;
(ii) credit risk: every transaction financed by the conduit has a triple-A monoline financial guaranty covering the timely payment of interest and the ultimate payment of principal by the legal final maturity of the respective asset securitization transaction. SLN noteholders or MTN noteholders face only the risk that the triple-A guarantor defaults on its payment obligations;
(iii) spread risk: in a traditional CP conduit, originator/sellers know up-front what interest rate they must pay if the conduit sponsor ever needed to retire maturing CP via the respective liquidity backstop facility. This interest rate (the “drawn rate”) is market driven and is typically in the range of LIBOR plus 50 basis points to 250 basis points per annum. With regard to the present invention and its drawn rate, originator/sellers funded by the conduit would pay an interest rate determined by the committed purchasers (including the lead underwriter), who would base such rate upon interest rates of similar triple-A-rated MTNs and other similar fixed-income securities in the primary and secondary markets at that time. The committed purchaser has its spread risk mitigated if not eliminated based on this structure. The spread over LIBOR, and hence the risk, are, according to the arrangement with the conduit whereby costs of funds are passed on to the originator/sellers, borne by the originator/sellers who may or may not have better financing options away from the conduit. However, it is possible that the originator/sellers would face lower costs with triple-A MTN pricing at the time of issuance, rather than a coupon of say, LIBOR plus 50-250 basis points per annum under traditional liquidity drawn pricing.

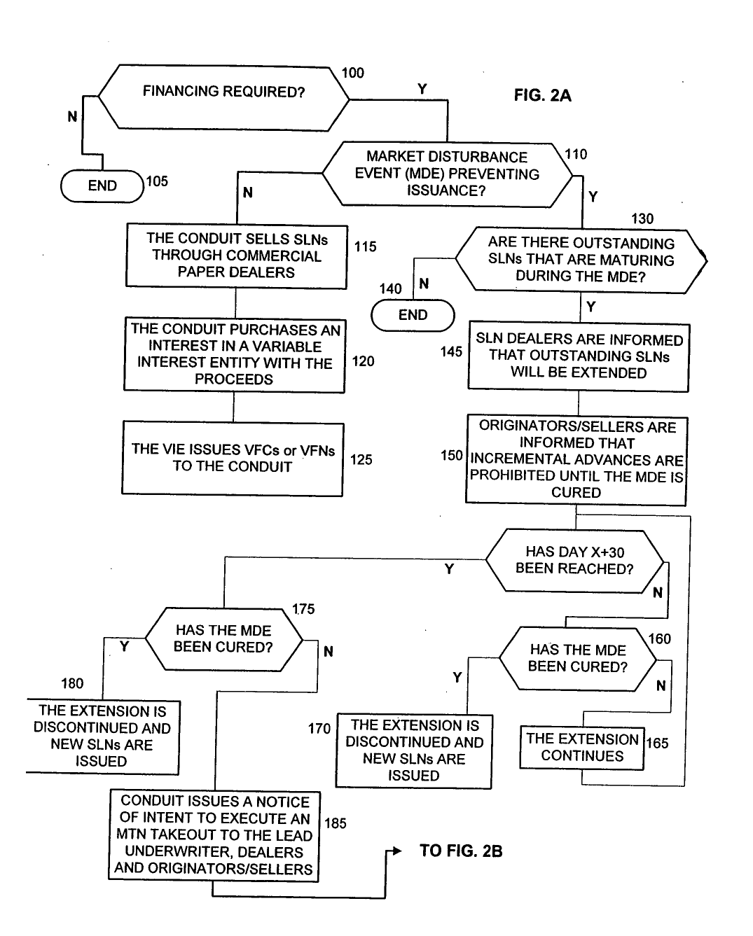

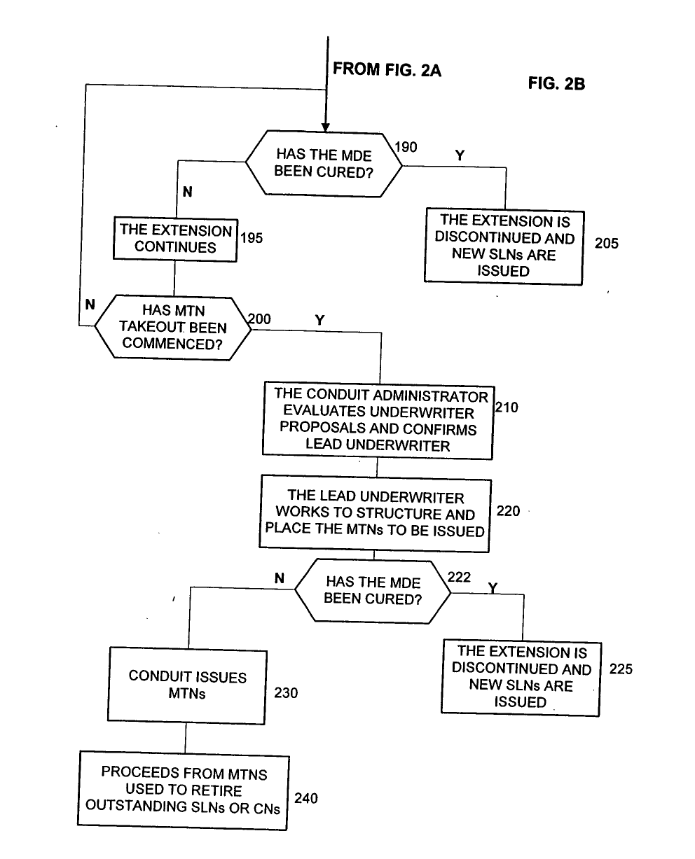

FIGS. 2a and 2b illustrate an example flow of events related to an issuance of SLNs by the conduit according to the present invention. Initially, it is determined (100) whether the conduit needs to finance asset-backed securitization investments. If not (105), no further steps need to be taken. If so, it is determined whether some event (e.g., a Market Disruption Event (“MDE”) has occurred that prevents the conduit from issuing new SLNs to finance new investments or retire maturing SLNs (110). If no MDE has occurred, the conduit sells SLNs through one or more commercial paper dealers (115). The principal amount of the SLNs or CNs will equal the principal amount of maturing SLNs or CNs plus any aggregate incremental investments. With the proceeds of the issued SLNs, the conduit may then purchase an asset-backed security (or like instrument), which is secured by the assets of a special purpose entity.

If an MDE has occurred, it is determined whether there are any outstanding SLNs that are maturing or have matured during the MDE (130). If there are not, no further steps are required (140). If there are (145), SLN dealers are informed that outstanding SLNs issued by the conduit will be extended (from day X), and the originator/sellers are informed that incremental advances are prohibited until the MDE has been cured and the extension discontinued (150). Simultaneously, dealers inform existing SLN holders that an extension has occurred and “step-up” interest rates now apply. Any CN holders also receive the “step-up” rate after the non-call period has expired.

Thereafter, on each succeeding day (X+1) through (X+29), it is determined whether the MDE has been cured (160). If not, the SLN extension continues (165). If the MDE has been cured, the extension is discontinued and new SLNs are issued (170), the principal amount of which equals all outstanding extended SLNs plus an incremental amount in respect of new investments. When day X+30 has been reached, it is again determined whether the MDE has been cured (175). If day X+30 has been reached and the MDE has been cured, the extension is discontinued and new SLNs are issued (180) as in step (170). If the MDE has not been cured at this point, the conduit may issue a notice of intent to execute a MTN Takeout to the lead underwriter, other dealers and the originator/sellers (185).

On day X+31, it is again determined whether the MDE has been cured (190). If not, the SLN extension continues (195) and the process cycles through steps (190) and (195) until the MTN Takeout has been commenced (200). If the MDE has been cured, new SLNs are issued (205) as in step (170). On day X+75 (210), the conduit administrator evaluates proposals received from the lead underwriter and other underwriters on behalf of the conduit, and on day X+90, the conduit administrator confirms, subject to a right of last offer, the lead underwriter. The lead underwriter then commences underwriting of the MTN issuance on behalf of the conduit. MTN funding occurs no later than 390 days from the initial issuance date of the earliest maturing SLN or CN (the “Final Funding Date”). During the time between the selection of the lead underwriter and the Final Funding Date, the lead underwriter works with the conduit, the rating agencies and other parties to structure and place the MTNs (or some other type of asset backed securities) to be issued (220). If at any time during this period, if the MDE is cured (222), the SLNs are issued (225) as in step (170). On or prior to the Final Funding Date, the conduit issues the MTNs that are underwritten by the lead underwriter (230), and proceeds from the MTN issuance are used to retire all extended SLNs or CNs (240).

In the foregoing description, the invention has been described with reference to a number of examples that are not to be considered limiting. Rather, it is to be understood and expected that variations in the principles of the system and methods for providing a backstop facility supporting and facilitating the issuance of extendable CP herein disclosed may be made by one skilled in the art and it is intended that such modifications, changes, and/or substitutions are to be included within the scope of the present invention as set forth in the appended claims.

1. A method of facilitating issuance, by a conduit, of extendable CP having a plurality of asset-backed securitization transactions as collateral, the method comprising:
obtaining a triple-A-rated guaranty for each of the plurality of asset-backed securitization transactions; and
securing as a backstop facility an up-front commitment from a highly rated entity to purchase future conduit-issued, fixed-income, asset-backed securities;
wherein, according to the up-front commitment, the conduit issues such fixed-income, asset-backed securities in the event that it is unable to retire maturing extended CP via a combination of issuance of new extendable CP and collections arising from the plurality of asset-backed securitization transactions, proceeds of the purchase being used to retire outstanding extendable CP.

2. The method of claim 1, wherein the fixed-income, asset-backed securities that the committed purchaser commits to purchase include MTNs.

3. The method of claim 1, wherein the extendable commercial paper includes secured liquidity notes (SLNs).

4. The method of claim 3, wherein the extendable commercial paper further includes callable notes (CNs).

5. The method of claim 1, wherein the triple-A rated guaranty is provided by a monoline insurer.

6. The method of claim 1, wherein the committed purchaser includes a lead underwriter, the lead underwriter being responsible for structuring, pricing, and further syndicating a distribution of the MTNs.

7. The method of claim 6, wherein the conduit is managed by a conduit administrator, the conduit administrator notifying the lead underwriter of an intent to retire outstanding extendable commercial paper through the issuance of fixed-income, asset-backed securities to the committed purchasers before the end of an extension period.

8. A method of providing liquidity for an extendable CP issue comprising:
securing a backstop facility for retirement of outstanding extendable CP from a highly rated committed purchaser in the event that circumstances giving rise to an extension cannot be cured by the end of an extension period of the outstanding extendable CP;
wherein the committed purchaser agrees to purchase fixed-income, asset-backed securities issued by the conduit to finance the retirement of the outstanding extendable CP.

9. The method of claim 8, wherein the fixed-income securities include MTNs.

10. The method of claim 9, wherein an interest rate of the MTNs is decided upon approximately when the committed purchaser is informed it must honor its commitment to purchase the MTNs.

11. The method of claim 9, wherein the committed purchaser includes a lead underwriter.

12. The method of claim 11, wherein the lead underwriter is notified before an end of the extension period to execute its purchase of the MTNs to retire the outstanding extended CP.

13. The method of claim 11, wherein the committed purchaser is obligated to purchase the MTNs notwithstanding the fact that the circumstances that originally gave rise to the extendable CP extension have been resolved.

14. The method of claim 8, wherein the extendable CP includes at least one of secured liquidity notes (SLNs) and callable notes (CNs).

15. A backstop-facility provider for ensuring retirement of extendable CP by a legal final maturity date comprising:
at least one highly rated committed purchaser that agrees to commit itself in advance to purchase a future issue of fixed-income, asset-backed securities from a conduit, where such issuance is intended for financing retirement of outstanding extendable CP issued by the conduit by the legal final maturity date in the event the conduit cannot issue new extendable CP.

16. The backstop provider of claim 15, wherein the committed purchaser includes at-least-one highly rated entity, the at-least-one highly rated entity further including a lead underwriter.

17. The backstop provider of claim 15, wherein the at-least-one highly rated committed purchaser agrees in advance to purchase asset-backed medium-term notes (MTNs) issued by the conduit after the occurrence of an event that gives rise to the extension of extendable CP if such event has not been cured before a Final Funding Date of such extendable CP.

18. The backstop provider of claim 15, wherein at-least-one highly rated committed purchaser is notified by the conduit administrator a set time after an extension period begins for the outstanding extendable CP issued by the conduit, such notification instructing the at-least-one highly rated entity to purchase MTNs to retire the outstanding extendable CP.

19. A financial structure for facilitating issuance of extendable CP comprising:
a conduit for purchasing asset-backed securitization transactions and for issuing extendable commercial paper to finance purchases of such asset-backed securitization transactions, the extendable CP providing for an extension period under certain circumstances; and
a highly rated backstop provider, the backstop provider being committed in advance to purchase fixed-income, asset-backed securities issued by the conduit to finance retirement of extendable CP issued by the conduit if the conduit is unable to retire the extendable CP before an end of the extension period.

20. The financial structure of claim 19, further comprising:
a special purpose vehicle, the special purpose vehicle securitizing existing and future financial assets through creation of at least one of variable funding certificates and variable finding notes secured by such assets, the special purpose vehicle financing such assets by issuing at least one of variable finding certificates and variable finding notes to the conduit.

21. The financial structure of claim 18, further comprising:
a financial insurer, the financial insurer guaranteeing non-default for each of the asset-backed securitization transactions purchased by the conduit.

22. The financial structure of claim 20, wherein the financial insurer has a rating of at least AAA.

23. The financial structure of claim 19, further comprising:
a conduit administrator, the conduit administrator performing monitoring and administration functions on behalf of the conduit.

24. The financial structure of claim 23, wherein the extendable commercial paper includes secured liquidity notes (SLNs).

25. The financial structure of claim 23, wherein the highly rated backstop provider includes a lead underwriter.

26. The financial structure of claim 19, wherein the fixed-income asset-backed securities include asset-backed medium-term notes (MTNs).

27. The financial structure of claim 25, wherein the conduit administrator notifies the lead underwriter of an intent to retire outstanding extendable CP through a sale of MTNs to the committed purchasers a preset period before the end of the extension period.

28. The financial structure of claim 26, wherein the committed purchasers agree in advance to purchase the medium-term notes (MTNs) after an occurrence of an event giving rise to an extendable CP extension if such event has not been cured a set period before the end of the extension period.
